(19) United States
(12) Patent Application Publication
(10) Pub. No.: US 2015/0352779 A1
(43) Pub. Date: Dec. 10, 2015

(54) IN-MOULD LABELLING

(71) Applicant: INNOVIA FILMS LIMITED, Wigton Cumbria (GB)

(72) Inventors: Stephen LANGSTAFF, Wigton, Cumbria (GB); Mark DAVIDSON, Wigton, Cumbria (GB); David CARRUTHERS, Wigton, Cumbria (GB)

(21) Appl. No.: 14/761,849

(22) PCT Filed: Feb. 12, 2014
(86) PCT No.: PCT/GB2014/050405

§ 371 Date: Jul. 17, 2015

(30) Foreign Application Priority Data
Feb. 12, 2013 (GB) 1302465.8

(51) Int. Cl. B29C 65/70; B29C 59/14

(52) U.S. Cl. CPC B29C 65/70; B29C 59/14; B29L 2009/00

(57) ABSTRACT

The invention concerns a process for in-mould labelling of an article with a film, wherein at least a first surface of the film is plasma treated. The invention also concerns in-mould labelled articles obtainable by the process of the invention.

This application is a national stage application of International Patent Application No. PCT/GB2014/050405, filed Feb. 12, 2014, which claims priority to United Kingdom patent Application No. 1302465.8, filed Feb. 12, 2013. The entirety of the aforementioned applications is incorporated herein by reference.

### FIELD

The present invention relates to a method of manufacturing an in-mould labelled article using a label which is surface treated using plasma treatment to improve printability.

### BACKGROUND

The technique of in-mould labelling (IML) has been known for many years. It involves the use of paper or plastic labels which ultimately form an integral part of the moulded product. The in-mould labels must, therefore, be able to tolerate the heat applied during the moulding process. The resultant product is a pre-decorated item, such as a container or the like, which may be filled thereafter. In contrast to glue applied or pressure-sensitive labels which appear above the surface of the container, in-mould labels appear as part of the container. Effectively, in-mould labelling eliminates the need for a separate labelling process following the manufacture of the container, which reduces labour and equipment costs.

In-mould labels generally comprise a carrier base, consisting of a polymeric or biopolymeric carrier film, on which a decorative pattern or a written message is printed. The thus obtained label is subsequently positioned against a wall of a mould for injection moulding or for blow moulding or the like, held in place by various means, such as electrostatic forces or vacuum suction, and a polymeric article is moulded by injecting a mass of polymeric melt or by blowing a polymeric parison against the mould walls on which the in-mould label is applied. This causes the label to join the moulded article and can be regarded as an integral part of it. The adhesion of such labels to the polymeric article can be enhanced by applying a heat sealable layer (a film or a coating) onto the backing side (i.e. a non-printed surface) of the in-mould label which is to be in contact with the polymeric article.

In-mould labels can be used to cover a portion of a container or to cover the entire outer surface of a container. In the latter case, the in-mould label serves as an additional layer and may, therefore, enhance the structural integrity of the container.

It may be beneficial for in-mould labels to contain certain additives, for example, anti-static additives, anti-blocks and/or slip promoting additives. These types of additives typically make handling of the labels easier, especially when the labels are part of larger sheets of film. However, the use of such additives is not without disadvantages. In particular, labels comprising such additives often have poor printability, particularly when one or more of the additives in question is a migratory additive.

Co-pending application GB 1116633.7 (PCT/GB2012/052396) discloses a process for producing a printable film comprising: providing a web of film; at a first location subjecting at least a first surface of the film web to a modified atmosphere dielectric barrier discharge treatment; winding the film web onto a reel; transporting the wound film web to a second location; unwinding the film web from the reel; and subjecting the first surface of the film to corona treatment.

US 2010/326590 A1, US 2009/011183 A1, US 2007/218227 A1, EP 1553126 A1, WO 2009/011372 A1 and WO 2008/030202 A1 all relate to in-mould labelling.

Using printed labels for in-mould labelling of an article has numerous advantages, for example, the resultant article may be highly decorative and eye-catching or it may allow useful information to be displayed on the article.

There is a need for an in-mould labelling process which makes use of films with enhanced printability.

### DETAILED DESCRIPTION

According to the present invention there is provided a process for in-mould labelling of an article with a film, wherein at least a first surface of the film is plasma treated.

Preferably, the plasma treatment of the film takes place prior to the in-mould labelling process.

At least a first surface of the film may be treated using modified atmosphere plasma treatment i.e. a plasma treatment which takes place in a modified atmosphere rather than in air. Preferably, the modified atmosphere plasma treatment is modified atmosphere dielectric barrier discharge (MADBD) treatment.

The modified atmosphere of the MADBD treatment may contain an inert carrier gas such as a noble gas or nitrogen, and at least one functional or reducing fluid such as acetylene, ethylene, hydrogen or silane for example. Oxidising fluids may also be used, for example, oxygen, ozone, carbon dioxide, carbon monoxide, nitric and nitrous oxides, sulfur oxide, dioxide or trioxide.

At least a first surface of the film may be treated with corona discharge treatment. Corona discharge treatment is a treatment that takes place at a lower power, with wider electrode gaps than in MADBD treatment, and in atmosphere i.e. in air. MADBD and corona discharge treatment are terms of art which will be understood by the skilled addressees, such as manufacturers of films or in-mould labelled articles or operators of printing, laminating and coating machines.

Preferably, at least a first surface of the film is subjected to plasma treatment, for example MADBD treatment, and subsequently subjected to corona discharge treatment. It is contemplated that the film may be subjected to plasma or MADBD treatment and subsequently to corona discharge treatment, only on its first surface or, optionally, on both surfaces. When both surfaces are treated, it is sufficient for the purposes of this invention that only one surface of the film be subjected to both plasma or MADBD treatment and subsequently to corona discharge treatment. The other surface of the film may be subjected to the same or similar treatment to the first surface, or to different treatment, for example, only to plasma or MADBD treatment or only to corona discharge treatment.

In co-pending application GB 1116633.7 (PCT/GB2012/052396), the inventors surprisingly found that the surface characterisation of the film caused by MADBD treatment can be revived, improved or reconstituted considerably after (even many months after) initial manufacture and MADBD treatment of the film by corona discharge treating the previously MADBD treated film. The combination of an initial MADBD treatment (normally during manufacture of the film) and a downstream corona treatment to refresh of even augment the surface properties of the MADBD treated film has not hitherto been recognised in the art.

Importantly, following plasma treatment, the film of the present invention is highly printable.

By ‘printable’ is preferably meant ‘ink printable’ and that in a standard ink pull-off tape test, scratch test, or UV flexo test conducted on a film according to the invention which has been printed on its first surface with a compatible ink and then cured (for example UV cured), if necessary, and allowed to age for 24 hrs before testing, preferably less than 50%, less than 40%, less than 30%, less than 20%, less than 10%, less than 5% or even as low as substantially 0%, of the ink is removed from the printed surface in the test.

Also by ‘ink printable’ is generally meant that in a standard ink pull-off tape test, scratch test, or UV flexo test conducted on a film according to the invention which has been printed on its first surface with a compatible ink and then tested immediately thereafter, less than 75%, preferably less than 60%, more preferably less than 50%, still more preferably less than 40% and most preferably less than 30% of the ink is removed from the printed surface in the test. In a particularly preferred embodiment of the invention, less than 20%, or even below 10%, of the ink is removed in such testing.

The film may be printed subsequent to being plasma treated, and is preferably printed before in-mould labelling. Preferably, the film is printed subsequent to plasma or MADBD treatment and corona discharge treatment, but before in-mould labelling. Preferably, the film is printed within 10 days, more preferably within 5 days, and most preferably within 1 day of the corona discharge treatment. Often printing will take place within hours, if not minutes, of the corona discharge treatment.

Printing of the film may be carried out by any known process, for example, UV Flexo, screen or combination printing, or gravure or reverse gravure printing, with at least one compatible ink.

The inventors of the present invention have found that there are two primary factors in connection with the properties of the film at its first surface which determine its printability. These are the surface chemistry of the film on the one hand and its surface energy on the other. Surface chemistry is determinative of the ability of the film to bind with an ink applied to the surface, whereas surface energy is determinative of the wetting characteristics of an ink applied to the surface. Good adhesion and/or good wettability may be necessary to achieve a good printable film.

In some instances, the surface energy of the film at its first surface may initially be increased by the plasma or MADBD treatment. The surface energy of the film at its first surface immediately after plasma or MADBD treatment may be at least about 46 dynes/cm, preferably at least about 50 dynes/cm, more preferably at least about 56 dynes/cm and most preferably at least about 60 dynes/cm.

In such instances, the surface energy of the film at its first surface immediately after plasma or MADBD treatment may be at least about 8 dynes/cm, preferably at least about 15 dynes/cm, more preferably at least about 20 dynes/cm and most preferably at least about 24 dynes/cm higher than the surface energy of the film at its first surface immediately before such plasma or MADBD treatment.

In such instances, after plasma or MADBD treatment, the surface energy of the film may decrease over time. Where the film is subjected to corona discharge treatment after plasma or MADBD treatment, immediately before corona discharge treatment, the surface energy of the film may have reduced from its amount immediately after plasma or MADBD treatment by at least about 10%, at least about 15%, at least about 20%, at least about 25% or at least about 50%. The surface energy of the film immediately after corona discharge treatment may be back to within at least about 20%, at least about 15%, or at least about 10%, of its value immediately after plasma or MADBD treatment. In some cases the surface energy of the film immediately after corona discharge treatment may even be above its surface energy immediately after plasma or MADBD treatment.

The surface chemistry of the film may also be affected by plasma or MADBD treatment. Clearly, the affected characteristics will depend not only upon the nature of the film surface but on other factors such as the nature of the modified atmosphere, the energy level of the plasma or MADBD treatment, the size of the electrode gap and the duration of the treatment. For the purposes of this invention it is sufficient to state that the surface of the film following plasma or MADBD treatment will comprise a number of polar chemical species not present on the film surface prior to plasma or MADBD treatment. Subsequent corona discharge treatment effects further changes to the surface chemistry of the film.

As disclosed in co-pending application GB 1116633.7 (PCT/GB2012/052396), the surface chemistry of the film can be characterised in terms of its functionality—that is to say, in particular the number of polar chemical species present at the surface of the film. Typically, the relative atomic concentration of polar chemical species measurable at the film surface immediately following plasma or MADBD treatment and subsequent exposure of the treated film to the atmosphere (whereupon any charged chemical species present on the film surface as a result of the plasma or MADBD treatment will be neutralized by the atmosphere) is y %, wherein y is a positive number. Because the effect of plasma or MADBD treatment dissipates over time as far as surface functionality is concerned, it is generally found that the relative atomic concentration of polar chemical species measurable at the film surface immediately prior to corona discharge treatment (after a period of time, generally of a least a few days, but often much longer, has elapsed after the initial plasma or MADBD treatment) is y−x %, wherein x is a positive number. Furthermore, because of the restorative or augmentative effect of the corona discharge treatment as concerns the functionality of the film, it is then found that the relative atomic concentration of polar chemical species measurable at the film surface immediately after the corona discharge treatment is y−x+z %, wherein z is a positive number.

Prior to plasma or MADBD treatment the surface of the film may, or may not, contain polar chemical species at its surface in any significant or substantial amount (above 1% relative atomic concentration for example). A polyolefin film for example essentially comprises only carbon-carbon and carbon-hydrogen bonds and is therefore substantially non-polar. On the other hand, a polyester film or an acrylic-coated film for example will already contain polar chemical species, including of course at its surface. The relative atomic concentration of polar chemical species measurable at the film surface immediately prior to plasma or MADBD treatment is q %, wherein q is zero or a positive number and wherein q is less than y. Preferably y−x+z is at least about 5, preferably at least about 10 greater than q.

y−x+z is preferably at least about 10, more preferably at least about 10.5, still more preferably at least about 11, and most preferably at least about 11.5, or even at least about 12.

The precise nature of the chemical functionality engendered at the surface of the film by plasma or MADBD treatment and/or by subsequent corona discharge treatment will depend upon many factors, including the chemical characteristics of the film itself at its surface (meaning or including, where applicable, the chemical composition of any skin layer or coating or lamination thereon), the nature of the modified atmosphere provided during the plasma or MADBD treatment, the power and duration of the plasma or MADBD treatment and/or the subsequent corona discharge treatment and other ancillary parameters such as the environment, both physical and chemical, in which the film is treated and/or maintained. Polar fragments may derive from the film itself and/or from the atmosphere in which the film is treated. In particular, polar fragments may derive from the modified atmosphere of the plasma or MADBD treatment, alone or in combination with materials from the film. For example, when the modified atmosphere of the plasma or MADBD treatment comprises nitrogen gas, there will likely be polar fragments comprising carbon-nitrogen bonds at the film surface after plasma or MADBD treatment.

The polar chemical species at the film surface after plasma or MADBD treatment may comprise one or more of the species selected from: nitrile; amine; amide; hydroxy; ester; carbonyl; carboxyl; ether and oxirane.

The technique of ToF-SIMS spectroscopy has been found to be a satisfactory method for measuring in qualitative terms the surface functionality (in terms of the identities of polar species present at the surface) of the film. However, for quantitative characterization (in terms of relative atomic concentration of polar species at the film surface) the inventors have found the technique of XPS spectroscopy to be more useful. Other determinative methods will be apparent to the skilled addressee.

Where the film comprises additives, such as anti-static additives, anti-blocks and/or slip promoting additives, these additives sometimes tend to migrate towards the surface of the film. It might be thought that the presence of such migratory additives on the film surface would prevent plasma treatment from beneficially affecting the film surface. However, it has surprisingly been found that this is not the case.

The inventors of the present invention have found that films comprising migratory additives, such as anti-static additives, anti-blocks and/or slip promoting additives, have improved printability following plasma treatment. It has also been found that when such additives are present in the film, the surface energy of the film is not necessarily increased following plasma treatment. Without wishing to be bound by any such theory, it is believed that in such instances, the improved printability is due to the change in the surface chemistry of the film following plasma treatment rather than an increase in surface energy or both.

One advantage of the present invention is that there is provided a printable film which can be used in a process for in-mould labelling of an article. It was previously thought that films comprising migratory additives could not be directly printed, or could not be directly printed to a sufficiently high standard to meet commercial requirements. Rather, it was thought that an additional printable layer or coating was required if such films were to be printed. However, the inventors of the present invention have unexpectedly found that a printable film can be obtained by plasma treating the film, for example using MADBD treatment, followed by corona discharge treatment. Advantageously, the printable films of the present invention can be printed and used in an in-mould labelling process.

The film may comprise a polyolefin film which may be selected from polyethylene, polypropylene, polybutylene, mixtures, blends, or copolymers (random or block) thereof and/or other known polyolefins. Biopolymeric films such as cellulosic or other carbohydrate or lactic acid based films (polylactic acid for example) are also contemplated, as are other film forming materials such as polyurethanes, polyvinylhalides, polystyrenes, polyesters, polyamides, acetates, and/or mixtures or blends thereof.

The total thickness of the film may vary depending on the application requirements. For example, the film may be from about 5 μm to about 100 μm thick, preferably from about 10 μm to about 80 μm thick, and most preferably from about 20 μm to about 70 μm thick.

The film may be a mono-layer film, or it may be a multi-layer film. In the latter case, the film may comprise at least one core layer forming a substantial element of the films overall thickness.

Where present, the core layer preferably has a maximum thickness of about 100 μm. More preferably, the core layer within the film has a maximum thickness of about 90 μm, about 80 μm, about 75 μm, about 70 μm, about 65 μm, about 60 μm, about 55 μm or about 50 μm. The core layer may have a thickness of about 50 μm to about 90 μm, or about 60 μm to about 80 μm, or about 65 μm to about 75 μm. It has been observed that films comprising core layers of excessive thicknesses perform less well, especially as compared to conventional in-mould label substrates.

Where present, the core layer may be provided as a single core layer. Alternatively, the core layer may comprise a plurality of layers tied together by one or more laminate layers, for example where the film is produced via the so called bubble process.

The laminate layer/s, if present, may be formed from polyolefins, such as polyethylene, polypropylene, polybutylene, or copolymers and/or blends thereof, including copolymers of ethylene and propylene, copolymers of butylene and propylene or terpolymers of propylene, ethylene and butylene.

The laminate layer/s, if present, preferably have a thickness of from about 0.1 μm to about 2 μm, more preferably from about 0.5 μm to about 1.5 μm.

The film may comprise one or more additional layers such as skin layers, coatings, co-extrudates, primer layers, overlaquers and the like.

The film may comprise at least one additional layer disposed on either or both surfaces of a core layer. Preferably, at least one additional layer is disposed on each surface of the core layer. This is preferable as it prevents the surfaces of the core layer from being exposed when the film is used in the in-mould labelling process. Furthermore, it may allow the provision of sealing layers on either side of the core layer. In some cases, the additional layer(s) on either side of the core layer may be of the same material; or they may be of different materials. In any event, the additional layer to be situated against the hot melt or blown preform during in-mould labelling, preferably seals at a lower temperature than that at which the core layer material would seal.

In preferred arrangements, the film independently includes one, two, or three skin layers and/or coatings on the inner and/or outer sides of a core layer.

The skin layers and/or coatings may independently be formed of or comprise a polyolefin material, such as polyethylene, polypropylene, polybutylene, mixtures, blends, or copolymers thereof and/or other known polyolefins. More specifically, the polyolefin material may comprise copolymers of ethylene and propylene, copolymers of butylene and propylene or terpolymers of propylene, ethylene and butylene. Additionally or alternatively, the film may comprise skin layers and/or coatings formed of or comprising polyvinylidene chloride (PVDC), biopolymeric materials, polyurethanes, polyvinylhalides, polystyrenes, polyesters, polyamides, acetates and/or mixtures or blends thereof.

The use of PVDC skin layers and/or coatings is advantageous as they allow the film to retain its oxygen barrier properties during and after a retort sterilisation or cooking process, during which conditions of high humidity are likely to be encountered. The PVDC coating inhibits the ingress of oxygen through the film even under such high humidity conditions. Examples of labels comprising PVDC skin layers are disclosed in PCT/GB2011/050153.

Preferably, the skin layers have a thickness substantially below that of the core layer. For example, the skin layers may independently have a thickness of from about 0.05 μm to about 2 μm, preferably from about 0.075 μm to about 1.5 μm, more preferably from about 0.1 μm to about 1.0 μm and most preferably from about 0.15 μm to about 0.7 μm.

Where the film has a multi-layer structure, the structure may be symmetrical e.g. A/B/C/B/A or A/B/A, or it may have an asymmetrical structure, where different numbers of additional layers are provided on either side of a core layer, and/or where the composition of the layers provided on either side of a core layer differs.

The film may comprise at least one additive which is optionally migratory. Where the film has a multi-layer structure, the additive may be present in any one or more of the film layers. In particular, the additive may be present in the core layer and/or any skin layers and/or any coatings.

Preferably, the film comprises at least one anti-static additive, anti-block additive and/or slip promoting additive. More preferably, the anti-static additive, anti-block additive and/or the slip promoting additive are migratory. The anti-static additive may be cationic, anionic and/or non-ionic, for example, poly-(oxyethylene) sorbitan monooleate. The anti-block additive may be silica, for example, with an average particle size from about 1 μm to about 10 μm. The slip promoting additive may be a hot slip aid or cold slip aid and may improve the ability of a film to slide satisfactorily across surfaces at about room temperature, for example, microcrystalline wax.

The anti-static additive may be present in the film in an amount of from about 0.1% to about 1% by weight. Preferably, the anti-static additive is present in the film in an amount of from about 0.2% to about 0.8% by weight and more preferably, in an amount of from about 0.3% to about 0.6% by weight. The slip promoting additive may be present in the film in an amount of from about 0.01% to about 0.5% by weight. Preferably, the slip promoting additive is present in the film in an amount of from about 0.015% to about 0.1% by weight and more preferably, in an amount of from about 0.02% to about 0.05% by weight.

The inventors of the present invention have unexpectedly found that by plasma treating the film, good printability can be achieved even when significant quantities of migratory anti-static additives, anti-block additives and/or slip promoting additives are present in the film. Without wishing to be bound by any such theory, it is believed that the migration of low molecular weight additives, such as those mentioned above, to the surface of the film disrupts the anchorage of the printing ink to the film, thus, reducing the printability of the film. However, by plasma treating the film in accordance with the present invention, the inventors have found that these negative effects on printability are significantly reduced or eliminated.

Additionally or alternatively, the additives may be selected from one or more of the following, mixtures thereof and/or combinations thereof: UV stabilisers, UV absorbers, dyes; pigments, colorants; metallized and/or pseudo-metallized coatings; lubricants, anti-oxidants, surface-active agents, stiffening aids; gloss improvers, prodegradants, barrier coatings to alter the gas and/or moisture permeability properties of the film (such as polyvinylidene halides, e.g. PVDC); tack reducing additives (e.g. fumed silica); particulate materials (e.g. talc); additives to reduce the coefficient of friction (COF) (e.g. terpolymers of about 2 to 15 weight % of acrylic or methacrylic acid, 10 to 80 weight % of methyl or ethyl acrylate, and 10 to 80 weight % of methyl methacrylate, together with colloidal silica and carnauba wax, as described in U.S. Pat. No. 3,753,769); sealability additives; additives to further improve ink adhesion and/or printability, cross-linking agents (e.g. melamine formaldehyde resin); adhesive layers (e.g. a pressure sensitive adhesive); and/or an adhesive release layer (e.g. for use as a liner in peel plate label applications).

The film may be formulated from materials to ensure that it is transparent or at least translucent. Alternatively, where an opaque film is required, pigment (e.g. in an amount of from 8% to 10%) may be provided in the core layer or additional layers of the film. Where a white-coloured film is required, the pigment used may be titanium dioxide.

The film may be made by any process known in the art, including, but not limited to, cast sheet, cast film and blown film. The film may be produced by, for example, coextrusion, coating e.g. extrusion coating, lamination or any combination thereof.

The film may be prepared as a balanced film using substantially equal machine direction (MD) and transverse direction (TD) stretch ratios, or can be unbalanced, where the film is significantly more orientated in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

The film may be mono-oriented in either the machine or transverse directions. However, in preferred embodiments, the film is biaxially oriented.

The film may shrink on the application of heat. The film may exhibit a maximum shrink force during residual shrinkage immediately after the application of heat of not more than 500 cN. Preferably, the maximum shrink force exhibited by the film during residual shrinkage is not more than 400 cN, more preferably not more than 300 cN, and most preferably not more than 250 cN.

The film may exhibit a maximum shrink force during residual shrinkage of the film immediately after exposure of the film to a temperature of 120° C. for a three minute period of not more than about 500 cN, preferably not more than about 400 cN, more preferably not more than about 300 cN and most preferably not more than about 250 cN.

Residual shrinkage may be defined as the continued shrinkage of the film once it has stopped being heated. The period of time during which residual shrinkage occurs is generally one or two or three or several minutes immediately after the cessation of heating.

The maximum shrink force in this context is the maximum shrink force in either the machine or the transverse direction of the film.

The shrink force exhibited by the film during shrinkage may be an important parameter as far as the efficacy of the film in in-mould labelling is concerned. It is believed that many prior art in-mould labelling films exhibit excessive shrink forces immediately after the application of heat during in-mould labelling, which causes the film to distort as it cools.

It has been recognised by the inventors that the distortion effect observed when conventional biaxially oriented polypropylene films are used as in-mould labels, is not related to the ultimate degree of shrinkage of the film, but rather to the force by which the film shrinks.

According to another aspect of the present invention, there is provided a process for in-mould labelling of an article with a printable film, wherein at least a first surface of the film is plasma, preferably MADBD, treated, and wherein the film comprises at least one anti-static additive, anti-block additive and/or a slip promoting additive.

According to another aspect of the present invention, there is provided an in-mould labelling process comprising the following steps:
placing the plasma-treated film, in the form of a label, into a mould for injection moulding, thermoforming, or blow moulding;
holding the label in position;
injecting a polymeric melt into, or thermoforming or blowing a polymeric preform in said mould to form an article which binds with the label; and
removing the labelled article from the mould.

During the in-mould labelling process, the label may be held in position in the mould by at least one of a vacuum, compressed air and static electricity.

The label may be placed into the mould by at least one of feeding the label into the mould by means of a belt, the label falling under gravity from a magazine into the mould, and placing of the label by a handling unit, preferably a robot. Use of a robot is preferable as it minimises human error and improves sanitation of the final product.

The mould may be at a lower temperature than that of the molten polymer for forming the article e.g. the polymeric melt or the polymeric preform. The mould may be chilled so that the molten polymer supplied to the mould cools and hardens rapidly against the mould surface once injected. The temperature of the mould may be in the range of from about 32° C. to about 66° C. while typical in-mould labelling temperature conditions are from about 191° C. to about 232° C.

The label may cover the entire outer surface of the article. Alternatively, only a portion of the outer surface of the article may be covered by the label. Preferably, the label covers at least about 50% of the surface of the article. Label coverage of the article may be dependent on the intended use of the article.

According to another aspect of the present invention, there is provided a process comprising the steps of:
a. providing a web of film;
b. at a first location subjecting at least a first surface of the film web to plasma, preferably MADBD, treatment;
c. winding the film web onto a reel;
d. transporting the wound film web to a second location;
e. unwinding the film web from the reel;
f. subjecting the first surface of the film to corona discharge treatment;
g. printing the film web
h. forming an in-mould labelled article using at least a part of the film web as a label.

The first location and second location may be remote from one another. The first location may be a first factory or manufacturing site and the second location may be a second factory or manufacturing site. The process may allow a film manufacturer to operate steps a) and b) of the process to produce a printable film, which film can then be wound onto a reel and shipped to a customer (steps c) and d) of the process), such as a printer or converter, who will then operate steps e) and f) of the process and thereby refresh the film's printability performance following the diminishment in that performance that takes place during steps c), d) and e) of the process. The customer may then print the film according to step g). Preferably this is done within the time limits outlined previously. The same or different customer may then use the film web to form one or more labels which can be used in an in-mould labelling process.

According to another aspect of the present invention, there is provided an article labelled by the process as described above.

The article may have substantially no distortion in its label.

The invention is further described by way of the following examples, which are by way of illustration only, and are not limiting to the scope of the invention described herein.

### EXAMPLES

A biaxially oriented polymeric film having a core layer of a random copolymer of polypropylene and polyethylene and coextruded skin layers of a polypropylene/polyethylene/polybutylene terpolymer was manufactured by means of a bubble process. The film has a total thickness of 55 μm, with the skin layers between them constituting less than 1 μm of that thickness.

Examples 1 to 6 below all used this film as a starting material.

Corona discharge treatment of the film involved an electrical process using ionized air to increase the surface tension of non-porous substrates. Corona discharge treatment converts the substrate surface from a normally non-polar state to a polar state. Oxygen molecules from the corona discharge area are then free to bond to the ends of the molecules in the substrate being treated, resulting in an increase in surface tension. Generally a film to be treated would pass under a filament where a streaming discharge though the air would earth on the film at speeds appropriate for a printing process.

MADBD treatment of the film differs from corona treatment in that the rate at which electron bombardment occurs is up to 100 times greater. This increased cross-linking activity forces a greater ion bombardment onto the substrate surface. This result increases etching of the substrate's surface, and stronger bonding attributes across the length of the film. In addition to these surface reactions, plasma also facilitates the use of chemical gases which can produce controlled chemical reactions on the surface as well. Generally a film to be treated would pass under a series of solid electrodes where a glow discharge though the modified atmosphere would earth on the film at speeds appropriate for a coating process.

### Examples 1 to 6

The following film samples were used:

Example 1: untreated film (control; comparative).

Example 2: film treated with MADBD at 50 w/cm² in an atmosphere of N₂ and acetylene; 100 ppm acetylene.

Example 3: film treated with MADBD at 55 w/cm² in an atmosphere of N₂ and acetylene; 75 ppm acetylene.

Example 4: film treated with MADBD at 45 w/cm² in an atmosphere of N₂ and acetylene; 100 ppm acetylene.

Example 5: film treated with MADBD at 75 w/cm² in an atmosphere of N₂ and acetylene; 100 ppm acetylene.

Example 6: film treated with MADBD at 65 w/cm² in an atmosphere of N₂ and acetylene; 100 ppm acetylene.

Two samples of each film were prepared and each sample was left without further treatment for a 10 day period. At the end of that period of time, one sample of each film was corona treated at 50 m/min; the other was not.

All films were subjected to an ink adhesion test using a Sericol ink in a UV Flexo process followed by a scratch test. The scratch test was conducted using a nickel coin held at approximately 45 degrees and dragged away from the tester.

The results are presented in Table 1, wherein ink adhesion is measured on a scale of 1 to 3 (1 being relatively good and 3 being relatively poor). “N/A” indicates complete non-adhesion of the ink.

TABLE 1

| | Ink adhesion | Ink adhesion |
|---|---|---|
| | score for | score for |
| | the non-corona | the corona |
| Film Sample | treated sample | treated sample |
| Example 1 | 3 | 3 |
| (control) | | |
| Example 2 | 3 | 1.5 |
| Example 3 | 3 | 1.5 |
| Example 4 | N/A | 1.5 |
| Example 5 | N/A | 1 |
| Example 6 | N/A | 1 |

The results demonstrate that in relation to the control sample, corona discharge treatment of the film makes no marked difference to the film's ink adhesion performance. In contrast, films treated by MADBD and then aged (by 10 days) show a marked improvement in ink adhesion performance upon corona discharge treatment.

### Examples 7 and 8

The film of Example 1 was taken and MADBD treated in an atmosphere of nitrogen/acetylene; 200 ppm acetylene at 65 w/cm². The resulting film after brief exposure to the atmosphere (Example 7) was then surface characterised by XPS spectroscopy to determine the relative atomic concentration of polar species at its surface. The film was then re-tested by the same technique after being aged for 2 weeks (Example 8).

The results are presented in Table 2.

TABLE 2
Relative atomic concentration (%)

| Sample | C—C\C—H | C—N | C—OH | C—O—O— | C═O | —O—C═O | Other* |
|---|---|---|---|---|---|---|---|
| Example 7 | 76.2 | 7.7 | 2 | 0.9 | 0.6 | 0.2 | 12.4 |
| Example 8 | 77.2 | 6.8 | 2 | 1.1 | 0.6 | — | 12.5 |

*Does not include any substantial amount of polar species.

ther 1 of are presented in Table 2.ed for 2 weeks. concentration of polar species at its surface. The film was then re-tested

The total relative atomic concentration of polar species measurable at the film surface by XPS spectroscopy was 11.4% immediately after MADBD treatment, and 10.5% after aging of the film for two weeks, representing a significant deterioration in the ability of the film to bind a UV flexo ink, for example.

Subsequent corona treatment of the aged film causes the relative atomic concentration of polar species measurable at the film surface to rise to 11.2%.

### Examples 9 and 10

The film of Example 1 was taken and MADBD treated in an atmosphere of nitrogen/acetylene; 75 ppm acetylene at 65 w/cm². The treated film was aged for a period of approximately 2 months (Example 9) and then the resulting film was surface characterised by XPS spectroscopy to determine the relative atomic concentration of polar species at its surface. The film was then re-tested by the same technique after being aged for approximately 10 months (Example 10).

The results are presented in Table 3.

TABLE 3
Relative atomic concentration (%)

| Sample | C—C\C—H | C—N | C—O* | —O—C═O | Other** |
|---|---|---|---|---|---|
| Example 9 | 84.5 | 4.4 | 3.4 | — | 7.7 |
| Example 10 | 84.6 | 4.6 | 3.1 | — | 7.7 |

*The C—O bonds are likely to be surface C—OH bonds.
**Does not include any substantial amount of polar species.

### Examples 11 and 12

A film sample of the same type as used as the control sample in Examples 1 to 6 was taken and subjected to MADBD at 65 w/cm² in an atmosphere of N₂ and acetylene; 75 ppm acetylene.

The treated film was aged for a period of six months and then its surface energy was measured using dyne solutions from Sherman.

The aged film was then corona treated at 0.3 kW and 20 m/min and its surface energy measured again.

The results are presented in Table 4.

TABLE 4

| | Surface energy |
|---|---|
| Sample | (dynes/cm) |
| Example 11—MADBD treated and aged | 46 |
| Example 12—subsequently corona treated | 54 |

The results indicate that the surface energy of the film following MADBD treatment and subsequent aging can be re-boosted following corona treatment.

### Examples 13 and 14

Two films were manufactured as follows:

### Example 13

### Clear Film

A clear biaxially oriented polymeric film having a core layer comprising two layers of a random copolymer of polypropylene and polyethylene tied together by a lamination layer of a polypropylene/polyethylene/polybutylene terpolymer and coextruded skin layers of a propylene/butylene/ethylene terpolymer, was manufactured by means of a bubble process. The film had a total thickness of 55 μm, with each skin layer constituting 0.4 μm of that thickness.

The core layer of the film comprised glycerol mono stearate in an amount of 0.2625% by weight and ethoxylated amine in an amount of 0.175% by weight as anti-static additives. The core layer further comprised erucic acid amide in an amount of 0.03% by weight as a slip promoting additive. The skin layers contained an anti-block additive.

### Example 14

### White Film

A white biaxially oriented polymeric film having a core layer comprising two layers of a random copolymer of polypropylene and polyethylene tied together by a lamination layer of a polypropylene/polyethylene/polybutylene terpolymer and coextruded skin layers of a HDPE/polypropylene blend, was manufactured by means of a bubble process. The film had a total thickness of 55 with each skin layer constituting 1.5 μm of that thickness.

The core layer of the film contained glycerol mono stearate in an amount of 0.2625% by weight and ethoxylated amine in an amount of 0.175% by weight as anti-static additives, and erucic acid amide in an amount of 0.03% by weight as a slip promoting additive. The core layer further comprised approximately 9% by weight of a titanium dioxide pigment.

Each film was MADBD treated at 65 w/cm² in an atmosphere of N₂ and acetylene; 75 ppm acetylene. The surface energy of the film was measured immediately after MADBD treatment using dyne solutions from Sherman. The results are presented in Table 5.

TABLE 5

| | Surface Energy |
|---|---|
| Sample | (dynes/cm) |
| Example 13—Clear Film | unchanged |
| Example 14—White Film | 58 |

From the results, it can be seen that there was no increase in surface energy following MADBD treatment of the clear film. Conversely, the white film showed a significant increase in surface energy following MADBD treatment.

Without wishing to be bound by any such theory, it is contemplated that less of the anti-static additive and slip promoting additive migrate to the surface of the white film and thus, the film surface is more affected by the MADBD treatment. In addition to this, it is contemplated that the higher surface energy of the white film is at least partially due to the surface topography of the film i.e. HDPE islands in a sea of polypropylene.

The films of examples 2 to 14 are then printed and made into labels for use in an in-mould labelling process as described below.

Each label in turn is placed into a mould for injection moulding and is held in place using vacuum suction. A polymeric melt is injected into the mould which binds to the label and subsequently cools and hardens. The labelled article is then removed from the mould.

1. A process for in-mould labelling of an article with a film, comprising:
treating at least a first surface of the film with plasma.

2. The process according to claim 1, wherein the film comprises at least one migratory additive.

3. The process according to claim 2, wherein the migratory additive comprises one or more of:
a slip promoting additive
an anti-static additive
an anti-block additive.

4. The process according to claim 1, wherein the film comprises a polyolefin film; a biopolymeric film; a polyurethane; a polyvinylhalide; a polystyrene; a polyester; a polyamide; an acetate; and/or mixtures or blends thereof.

5. The process according to claim 4, wherein the polyolefin film is selected from polyethylene, polypropylene, polybutylene, mixtures, blends, or copolymers thereof and/or other known polyolefins.

6. The process according to claim 1, wherein the total thickness of the film is from about 5 μm to about 100 μm.

7. The process according to claim 1, wherein the total thickness of the film is from about 10 μm to about 80 μm.

8. The process according to claim 1, wherein the total thickness of the film is from about 20 μm to about 70 μm.

9. The process according to claim 1, wherein the film comprises one or more skin layers and/or coatings.

10. The process according to claim 9, wherein the film comprises a core layer having a thickness of
i. about 50 μm to about 90 μm,
ii. about 60 μm to about 80 μm, or
iii. about 65 μm to about 75 μm.

11. The process according to claim 9, wherein the one or more skin layers and/or coatings comprise a polyolefin material; polyvinylidene chloride; biopolymeric materials; polyurethanes; polyvinylhalides; polystyrenes; polyesters; polyamides; acetates and/or mixtures or blends thereof.

12. The process according to claim 1, comprising the steps of:
placing the plasma-treated film, in the form of a label, into a mould for injection moulding, thermoforming, or blow moulding;
holding the label in position;
injecting a polymeric melt into, or thermoforming or blowing a polymeric preform in said mould to form an article which binds with the label; and
removing the labelled article from the mould.

13. The process according to claim 12, wherein the label is held in position by at least one of a vacuum, compressed air and static electricity.

14. The process according to claim 12, wherein the label is placed into the mould by at least one of feeding the label into the mould by means of a belt, the label falling under gravity from a magazine into the mould, and placing of the label by a handling unit, preferably a robot.

15. The process according to claim 12, wherein the mould is at a lower temperature than that of the polymeric melt and/or the polymeric preform.

16. The process according to claim 12, wherein the label covers at least about 50% of the surface of the article.

17. The process according to claim 1, wherein the plasma treatment is a modified atmosphere plasma treatment.

18. The process according to claim 17, wherein the modified atmosphere plasma treatment is MADBD treatment.

19. The process according to claim 17, wherein the modified atmosphere contains at least one inert carrier gas and at least functional fluid.

20. The process according to claim 19, wherein the functional fluid comprises at least one reducing fluid and/or at least one oxidising fluid.

21. The process according to claim 17, wherein the surface energy of the film at its treated surface immediately after plasma treatment is
i. at least about 46 dynes/cm,
ii. at least about 50 dynes/cm,
iii. at least about 56 dynes/cm, or
iv. at least about 60 dynes/cm.

22. The process according to claim 17, wherein the surface energy of the film at its treated surface immediately after plasma treatment is
i. at least about 8 dynes/cm,
ii. at least about 15 dynes/cm,
iii. at least about 20 dynes/cm, or
iv. at least about 24 dynes/cm
higher than the surface energy at the treated surface immediately before the plasma treatment.

23. The process according to claim 1, wherein the at least one surface of the film is corona discharge treated.

24. The process according to claim 1, wherein the at least one surface of the film is subjected to plasma treatment followed by corona discharge treatment.

25. The process according to claim 23, wherein the plasma treatment and corona discharge treatment of the at least one surface of the film are carried out prior to the in-mould labelling of the article with the film.

26. The process according to claim 1, wherein the film is printed subsequent to the plasma treatment.

27. The process according to claim 1, wherein the film is subjected to plasma treatment and corona discharge treatment and is subsequently printed.

28. The process according to claim 27, wherein printing takes place
i. within 10 days,
ii. within 5 days, or
iii. within 1 day
of corona discharge treatment.

29. The process according to claim 1, wherein the film is printed prior to the in-mould labelling of the article with the film.

30. The process according to claim 24, wherein after plasma treatment the surface energy of the film decreases over time.

31. The process according to claim 30, wherein by the time the film web is about to be subjected to corona treatment, the surface energy has reduced from its amount immediately after plasma treatment by:
i. at least about 10%;
ii. at least about 15%;
iii. at least about 20%;
iv. at least about 25%; or
v. at least about 50%.

32. The process according to claim 31, wherein immediately after the corona treatment the surface energy of the film returns to at least within about:
i. 20%;
ii. 15%; or
iii. 10%
of its value immediately after plasma treatment.

33. The process according to claim 32, wherein the surface energy of the film immediately after corona discharge treatment is above its surface energy immediately after plasma treatment.

34. The process according to claim 23, wherein the surface of the film immediately following plasma treatment comprises a number of polar chemical species not present on the film surface prior to plasma treatment.

35. The process according to claim 34, wherein the relative atomic concentration of polar chemical species measurable at the film surface immediately following plasma treatment is y %, wherein y is a positive number.

36. The process according to claim 35, wherein the relative atomic concentration of polar chemical species measurable at the film surface immediately prior to the corona treatment is y−x %, wherein x is a positive number.

37. The process according to claim 36, wherein the relative atomic concentration of polar chemical species measurable at the film surface immediately after the corona treatment is y−x+z %, wherein z is a positive number.

38. The process according to claim 37, wherein y−x+z is:
a. at least about 10%;
b. at least about 10.5%;
c. at least about 11%;
d. at least about 11.5%; and/or
e. at least about 12%.

39. The process according to claim 35, wherein the relative atomic concentration of polar chemical species at the film surface is measurable, or is measured by the technique of XPS spectroscopy.

40. A process comprising the steps of:
a. providing a web of film.
b. at a first location subjecting at least a first surface of the film web to plasma treatment;
c. winding the film onto a reel;
d. transporting the wound film to a second location;
e. unwinding the film from the reel;
f. subjecting the first surface of the film to corona discharge treatment;
g. printing the film web;
h. forming an in-mould labelled article using at least a part of the film web on a label.

41. The process according to claim 40, wherein the second location is remote from the first.

42. The process according to claim 40, wherein the plasma treatment is MADBD treatment.

43. An article labelled by the process according to claim 1.
